(19) United States
(12) Patent Application Publication
(10) Pub. No.: US 2024/0220078 A1
(43) Pub. Date: Jul. 4, 2024

(54) METHOD FOR DISPLAYING INFORMATION, ELECTRONIC DEVICE, AND STORAGE MEDIUM

(71) Applicant: BEIJING DAJIA INTERNET INFORMATION TECHNOLOGY CO., LTD., Beijing (CN)

(72) Inventor: Zhen CHEN, Beijing (CN)

(21) Appl. No.: 18/398,514

(22) Filed: Dec. 28, 2023

(30) Foreign Application Priority Data
Dec. 30, 2022 (CN) 202211730546.3

(51) Int. Cl. G06F 3/0482; G06F 3/04817

(52) U.S. Cl. CPC G06F 3/0482; G06F 3/04817

(57) ABSTRACT

A method for displaying information is provided. The method includes: determining, in response to a picture set display operation, a plurality of pictures to be displayed from a picture set and thumbnails of the plurality of pictures; displaying a target interface, wherein the target interface includes the thumbnails of the plurality of pictures and switch elements corresponding to the thumbnails; and switching, in response to a trigger operation on the switch elements, to display pictures corresponding to the switch elements on the target interface.

This application claims priority to Chinese Patent Application No. 202211730546.3, filed on Dec. 30, 2022, and entitled “METHOD AND APPARATUS FOR DISPLAYING INFORMATION, ELECTRONIC DEVICE, AND STORAGE MEDIUM,” the disclosure of which is herein incorporated by reference in its entirety.

### TECHNICAL FIELD

The present disclosure relates to the field of internet technologies, and in particular, relates to a method for displaying information, an electronic device, and a storage medium.

### BACKGROUND

With the continuous development of internet technologies, users can post various types of content on a platform, including not only videos but also pictures. For example, a user can browse a picture set consisting of multiple pictures. In the case of browsing the picture set, the picture browsing efficiency needs to be ensured.

### SUMMARY

The present disclosure provides a method for displaying information, an electronic device, and a storage medium. The technical solutions of the present disclosure include the following.

According to an aspect of embodiments of the present disclosure, a method for displaying information is provided. The method includes:
determining, in response to a picture set display operation, a plurality of pictures to be displayed from a picture set and thumbnails of the plurality of pictures;
displaying a target interface, wherein the target interface includes the thumbnails of the plurality of pictures and switch elements corresponding to the thumbnails, wherein the pictures and the thumbnails are in one-to-one correspondence, and the thumbnails and the switch elements are in one-to-one correspondence; and
switching, in response to a trigger operation on the switch elements, to display pictures corresponding to the switch elements on the target interface.

In some embodiments, said determining, in response to the picture set display operation, the plurality of pictures to be displayed from the picture set and the thumbnails of the plurality of pictures includes:
displaying a cover picture interface of the picture set in response to the picture set display operation, wherein the cover picture interface includes a progress bar, the progress bar including a plurality of elements; and
determining, in response to a trigger operation on the progress bar, the plurality of pictures to be displayed from the picture set and the thumbnails of the plurality of pictures; wherein the switching elements on the target interface are displayed at the same positions as the elements of the progress bar, and displayed below the thumbnails.

In some embodiments, said determining, in response to the picture set display operation, the plurality of pictures to be displayed from the picture set includes:
determining, in response to the picture set display operation, a preceding target number of pictures in the picture set as the plurality of pictures to be displayed along with the thumbnails based on a display sequence of the pictures in the picture set.

In some embodiments, the target interface includes a thumbnail display region configured to display the thumbnails of the plurality of pictures; and the method further includes:
determining the target number based on a size of the thumbnail display region and a size of the thumbnails; or
determining the target number based on a predetermined display policy.

In some embodiments, said switching, in response to the trigger operation on the switch elements, to display the pictures corresponding to the switch elements on the target interface includes:
determining, in response to the trigger operation on the switch elements, a trigger sequence of the switch elements, and sequentially displaying, based on the trigger sequence, the pictures corresponding to the switch elements.

In some embodiments, the method further includes:
displaying, in response to a select operation on a target switch element, a picture corresponding to the target switch element on the target interface, and displaying the target switch element and a thumbnail corresponding to the target switch element with a predetermined display effect.

In some embodiments, the method further includes:
hiding, in response to stop of the trigger operation, the thumbnails of the pictures on the target interface.

In some embodiments, said determining, in response to the trigger operation on the progress bar, the plurality of pictures from the picture set includes:
determining, in response to a slide operation on the switch elements along a first direction, the plurality of pictures from the picture set.

In some embodiments, the target interface includes a thumbnail display region configured to display the thumbnails of the plurality of pictures; and the method further includes:
displaying, in response to a select operation on a target switch element, a target thumbnail corresponding to the target switch element at a target position in the thumbnail display region;
wherein sizes of thumbnails on left and right sides of the target thumbnail sequentially decrease, and are all smaller than a size of the target thumbnail; and
a size of an i^{th} thumbnail on the left side of the target thumbnail is consistent with a size of an i^{th} thumbnail on the right side of the target thumbnail, wherein i is a positive integer.

In some embodiments, the sizes of the thumbnails on the left and right sides of the target thumbnail sequentially decrease, and are all smaller than the size of the target thumbnail until (i+1)^{th} thumbnails on the left and right sides of the target thumbnail.

According to another aspect of embodiments of the present disclosure, an apparatus for displaying information is provided. The apparatus includes:
a first determining unit, configured to determine, in response to a picture set display operation, a plurality of pictures to be displayed from a picture set and thumbnails of the plurality of pictures;
a first displaying unit, configured to display a target interface, wherein the target interface includes the thumbnails of the plurality of pictures and switch elements corresponding to the thumbnails, wherein the pictures and the thumbnails are in one-to-one correspondence, and the thumbnails and the switch elements are in one-to-one correspondence; and
a second displaying unit, configured to switch, in response to a trigger operation on the switch elements, to display pictures corresponding to the switch elements on the target interface.

In some embodiments, the first determining unit is configured to:
display a cover picture interface of the picture set in response to the picture set display operation, wherein the cover picture interface comprises a progress bar, the progress bar comprising a plurality of elements; and
determine, in response to a trigger operation on the progress bar, the plurality of pictures to be displayed from the picture set and the thumbnails of the plurality of pictures; wherein the switching elements on the target interface are displayed at the same positions as the elements of the progress bar, and displayed below the thumbnails.

In some embodiments, the first determining unit is configured to:
determine, in response to the picture set display operation, a preceding target number of pictures in the picture set as the plurality of pictures to be displayed along with the thumbnails based on a display sequence of the pictures in the picture set.

In some embodiments, the target interface includes a thumbnail display region configured to display the thumbnails of the plurality of pictures; and the apparatus for displaying information further includes:
a second determining unit, configured to determine the target number based on a size of the thumbnail display region and a size of the thumbnail; or, a third determining unit, configured to determine the target number based on a predetermined display policy.

In some embodiments, the second displaying unit is configured to:
determine, in response to the trigger operation on the switch elements, a trigger sequence of the switch elements, and sequentially display, based on the trigger sequence, the pictures corresponding to the switch elements.

In some embodiments, the apparatus for displaying information further includes:
a third displaying unit, configured to display, in response to a select operation on a target switch element, a picture corresponding to the target switch element on the target interface, and display the target switch element and a thumbnail corresponding to the target switch element with a predetermined display effect.

In some embodiments, the apparatus for displaying information further includes:
a hiding unit, configured to hide, in response to stop of the trigger operation, the thumbnails of the pictures on the target interface.

In some embodiments, the first determining unit is configured to:
determine, in response to a slide operation on the switch elements along a first direction, the plurality of pictures from the picture set.

In some embodiments, the target interface includes a thumbnail display region configured to display the thumbnails of the plurality of pictures; and the apparatus for displaying information further includes:
a fourth displaying unit, configured to display, in response to a select operation on a target switch element, a target thumbnail corresponding to the target switch element at a target position in the thumbnail display region;
wherein sizes of thumbnails on left and right sides of the target thumbnail sequentially decrease, and are all smaller than a size of the target thumbnail; and
a size of an i^{th} thumbnail on the left side of the target thumbnail is consistent with a size of an i^{th} thumbnail on the right side of the target thumbnail, wherein i is a positive integer.

In some embodiments, the sizes of the thumbnails on the left and right sides of the target thumbnail sequentially decrease, and are all smaller than the size of the target thumbnail until (i+1)^{th} thumbnails on the left and right sides of the target thumbnail.

According to another aspect of the embodiments of the present disclosure, an electronic device is provided. The electronic device includes:
one or more processors; and
a memory, configured to store one or more instructions executable by the one or more processors;
wherein the one or more processors, when loading and executing the one or more instructions, are configured to:
determine, in response to a picture set display operation, a plurality of pictures to be displayed from a picture set and thumbnails of the plurality of pictures;
display a target interface, wherein the target interface includes the thumbnails of the plurality of pictures and switch elements corresponding to the thumbnails, wherein the pictures and the thumbnails are in one-to-one correspondence, and the thumbnails and the switch elements are in one-to-one correspondence; and
switch, in response to a trigger operation on the switch elements, to display pictures corresponding to the switch elements on the target interface.

According to another aspect of embodiments of the present disclosure, a non-transitory computer-readable storage medium is provided, wherein the storage medium stores one or more instructions executable by a processor of an electronic device. The processor of the electronic device, when loading and executing the one or more instructions, is configured to:
determine, in response to a picture set display operation, a plurality of pictures to be displayed from a picture set and thumbnails of the plurality of pictures;
display a target interface, wherein the target interface includes the thumbnails of the plurality of pictures and switch elements corresponding to the thumbnails, wherein the pictures and the thumbnails are in one-to-one correspondence, and the thumbnails and the switch elements are in one-to-one correspondence; and
switch, in response to a trigger operation on the switch elements, to display pictures corresponding to the switch elements on the target interface.

According to another aspect of embodiments of the present disclosure, a computer program product is provided, the computer program product includes instructions executable by a processor of an electronic device. The processor of the electronic device, when loading and executing the one or more instructions, is configured to:
determine, in response to a picture set display operation, a plurality of pictures to be displayed from a picture set and thumbnails of the plurality of pictures;
display a target interface, wherein the target interface includes the thumbnails of the plurality of pictures and switch elements corresponding to the thumbnails, wherein the pictures and the thumbnails are in one-to-one correspondence, and the thumbnails and the switch elements are in one-to-one correspondence; and
switch, in response to a trigger operation on the switch elements, to display pictures corresponding to the switch elements on the target interface.

It should be understood that both the foregoing general description and the following detailed description are exemplary and explanatory only and are not construed as limiting the present disclosure.

### BRIEF DESCRIPTION OF THE DRAWINGS

The accompanying drawings, which are incorporated in and constitute a part of the description, illustrate embodiments consistent with the present disclosure and, together with the description, serve to explain the principles of the present disclosure and are not construed as limiting the present disclosure.

FIG. 1 is a schematic diagram of an implementation environment of a method for displaying information according to some embodiments of the present disclosure.

FIG. 2 is a flowchart of a method for displaying information according to some embodiments of the present disclosure.

FIG. 3 is a flowchart of another method for displaying information according to some embodiments of the present disclosure.

FIG. 4 is a schematic diagram of a cover picture interface according to some embodiments of the present disclosure.

FIG. 5 is a schematic diagram of an interface according to some embodiments of the present disclosure.

FIG. 6 is a schematic diagram of another interface according to some embodiments of the present disclosure.

FIG. 7 is a schematic diagram of yet another interface according to some embodiments of the present disclosure.

FIG. 8 is a block diagram of an apparatus for displaying information according to some embodiments of the present disclosure.

FIG. 9 is a block diagram of an electronic device according to some embodiments of the present disclosure.

### DETAILED DESCRIPTION

In order to make the technical solutions of the present disclosure better understood, the technical solutions provided by the embodiments of the present disclosure are clearly and completely described hereinafter with reference to the accompanying drawings.

It should be noted that the terms “first,” “second,” etc. in the description and claims of the present disclosure and the above drawings are configured to distinguish similar objects, and do not have to be used to describe a specific order or sequence. It should be understood that the data so used is interchangeable under appropriate situations such that the embodiments of the present disclosure described herein can be implemented in other sequences than those illustrated or described herein. The implementations described in the following exemplary embodiments do not represent all implementations consistent with the present disclosure. Rather, they are merely examples of apparatus and methods consistent with some aspects of the present disclosure or as detailed in the appended claims.

It should be further noted that the user information (including, but not limited to, user device information, user personal information, etc.) and data (including, but not limited to, data for display or analyze, etc.) referred to in the present disclosure are information and data authorized by users or sufficiently authorized by each party.

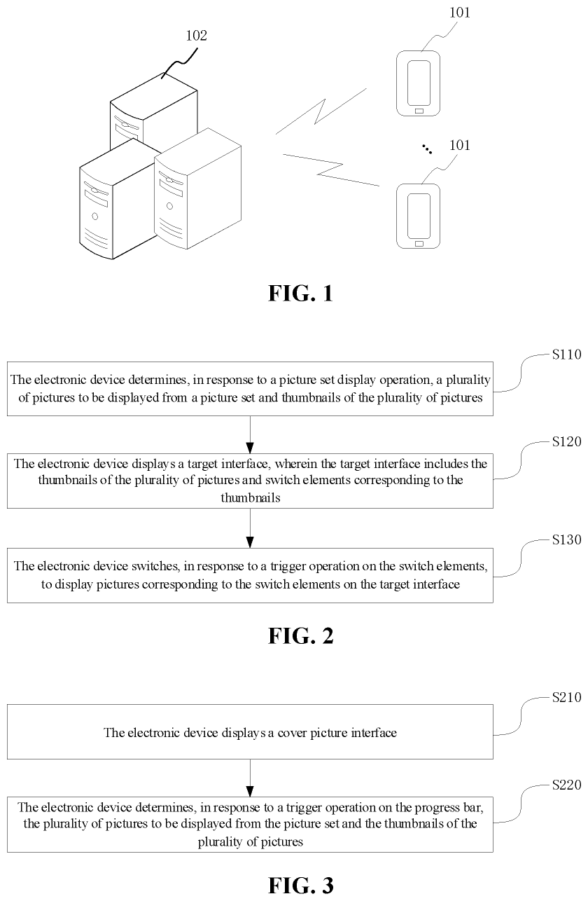

FIG. 1 is a schematic diagram of an implementation environment of a method for displaying information according to some embodiments of the present disclosure.

Referring to FIG. 1, the implementation environment includes a first electronic device 101 and a second electronic device 102, wherein the first electronic device 101 is provided with an application program. Exemplarily, the application program is an instant messaging application with an information display function, such as a short video application, which is not limited in the present disclosure.

In some embodiments, the type of the first electronic device 101 is not limited to various terminals, such as a personal computer, a laptop, a smart phone, a tablet computer, or a portable wearable device, etc. In addition, those skilled in the art can understand that the number of terminals may be more or less. For example, the number of terminals is only a few, or the number of devices is in tens or hundreds, or more. The number and the type of the terminals are not limited in the embodiments of the present disclosure.

In some embodiments, the second electronic device 102 provides a background service for a target application program, and the second electronic device is a server. In some examples, the target application program is an instant messaging application or other application program.

In addition, the second electronic device 102 is connected to the first electronic device 101 via a wireless network or a wired network. In addition, the server referred to in the embodiments of the present disclosure further includes other functional servers, so as to provide more comprehensive and diversified services.

In the related art, to browse pictures in a picture set in an application on an electronic device, a user can achieve the quick switching of the pictures by dragging the thumbnails of the pictures. However, the dragging operation may hide some content of the thumbnails, and the incomplete view of the thumbnail may affect the correct selection of the thumbnails and thus affect the browsing experience.

FIG. 2 is a flowchart of a method for displaying information according to some embodiments of the present disclosure. The method for displaying information is applicable to an electronic device, such as the first electronic device shown in FIG. 1, and as shown in FIG. 2, the method for displaying information includes the following processes.

In S110, the electronic device determines, in response to a picture set display operation, a plurality of pictures to be displayed from a picture set and thumbnails of the plurality of pictures.

In the process, the picture set is a picture set including a plurality of pictures, which is posted by a target user account through an application program, and the application program is run on the electronic device or other electronic device. The target user account posts the picture set in the application program upon logging in to the application program through the electronic device. The picture set display operation is configured to trigger to display a plurality of pictures included in the picture set on the electronic device, and may be performed by a user on a control displayed on an interface. The thumbnails are one-to-one corresponding to the target pictures, the content of the thumbnails is consistent with the content of the target pictures, and the size of the thumbnail is inconsistent with the size of the corresponding picture. Generally, the size of the thumbnail is smaller than the size of the corresponding picture, and the specific proportion is determined based on actual application scenes, which is not limited in the present disclosure.

In the embodiments of the present disclosure, a user triggers the picture set display operation on an electronic device based on a browsing requirement for the picture set in an application program, and accordingly, the electronic device determines, in response to the picture set display operation, a plurality of pictures to be displayed from the picture set corresponding to the picture set display operation, and determines a picture displayed in a thumbnail form of each of the plurality of pictures, namely a thumbnail.

In S120, the electronic device displays a target interface, wherein the target interface includes the thumbnails of the plurality of pictures and switch elements corresponding to the thumbnails.

In the process, the switch element is an interface display element configured to switch to display different pictures on the target interface.

In the embodiments of the present disclosure, the electronic device determines, in response to the picture set display operation, a second display position of the thumbnails of the plurality of pictures and a third display position of the switch element corresponding to each of the thumbnails, and based on this, the electronic device displays, based on the second display position and the third display position determined above, the target interface.

In some embodiments, the pictures, the thumbnails, and the switch elements are in one-to-one correspondence.

In some embodiments, the electronic device determines, in response to the picture set display operation, a background picture and determines a first display position of the background picture, a second display position of thumbnails of the plurality of pictures, and a third display position of switch elements corresponding to the thumbnails, and based on this, the electronic device displays, based on the first display position, the second display position, and the third display position, an interface including the background picture, the thumbnails of the pictures, and the switch element corresponding to each of the thumbnails. The background picture is a cover picture of the picture set or a first picture of the picture set. The first picture is a first picture in an order in which pictures in the picture set are displayed, and the first picture of the picture set is the same as or different from the cover picture and is determined based on a specific operation of a user.

In S130, the electronic device switches, in response to a trigger operation on the switch elements, to display pictures corresponding to the switch elements on the target interface.

In the process, the display position of the thumbnail on the target interface is aligned with the display position of the switch element corresponding to the thumbnail. That is, in a target direction, the size of the thumbnail is consistent with the size of the switch element, and in some embodiments, the target direction is horizontal. In some examples, the switch element is an elongated bar. At the horizontal direction, the length of the switch element is the same as the length/width of the thumbnail.

In the embodiments of the present disclosure, the electronic device determines, in response to the trigger operation on the switch elements, at least one switch element triggered by the trigger operation, and determines at least one picture corresponding to the at least one switch element, and based on this, the electronic device switches a cover picture displayed on the target interface to display the picture corresponding to the at least one switch element.

In some embodiments, the switch elements triggered by the trigger operation include switch element 3 and switch element 2, wherein picture 3 corresponds to the switch element 3, and picture 2 corresponds to the switch element 2. In this way, the electronic device updates, in response to the trigger operation on the switch element 2 and the switch element 3, the displayed first picture to picture 2 on the target interface, and updates, as the user switches from the switch element 2 to the switch element 3, the displayed picture 2 to the picture 3 on the target interface.

According to the method for displaying information, the thumbnails of the pictures and the switch elements corresponding to the thumbnails are displayed on the interface, and then the pictures are switched to be displayed through the trigger operation on the switch elements rather than an operation on the thumbnail directly, thereby not only the display completeness of the thumbnails or clear views of the thumbnails can be ensured, but also quick switch of the plurality of pictures in the picture set can be achieved, and thus the user experience is improved.

In some embodiments, determining, in response to the picture set display operation, the plurality of pictures to be displayed from the picture set and the thumbnails of the plurality of pictures is achieved by the following processes illustrated in FIG. 3.

In S210, the electronic device displays a cover picture interface.

In the process, the cover picture of the picture set may be the first picture in an order in which pictures in the picture set are displayed, or may be a picture determined based on the cover picture determination operation of the user, which is not limited in the present disclosure. The cover picture display interface is the interface configured to display the cover picture in the picture set, and the cover picture interface further includes a progress bar, wherein the progress bar includes a plurality of elements. In some embodiments, the arrangement of the elements of the progress bar is the same as the arrangement of the switch elements displayed on the target interface or the configuration of the plurality of the elements of the progress bar is the same as the plurality of the switch elements displayed on the target interface displayed subsequently. In some embodiments, the progress bar is a control to trigger the display of the target interface.

In some embodiments, the cover picture interface is a browsing interface of an application program. In the case that the browsing interface is configured to display a video, the information displayed on the browsing interface is a video cover picture; and in the case that the browsing interface is configured to display the picture set, the information displayed on the browsing interface is a cover picture of the picture set. In addition, the browsing interface further includes a progress bar, wherein the progress bar is composed of a plurality of elements. In some embodiments, upon switching to the target interface from the cover picture interface, the plurality of the switch elements are displayed on the same positions of the plurality of the elements in the progress bar. The switch elements correspond to the thumbnails on the target interface. A plurality of thumbnails form a thumbnail sequence, and in the thumbnail sequence, the arrangement order of the thumbnails is the same as the arrangement order of the plurality of switch elements.

In the embodiments of the present disclosure, the electronic device displays, based on a start operation for the application program triggered by the user, the cover picture interface of the picture set, or the electronic device displays, in response to the select operation on the picture set by the user, the cover picture interface of the picture set. In some examples, the selection operation may be a control indicating the picture set on the application program.

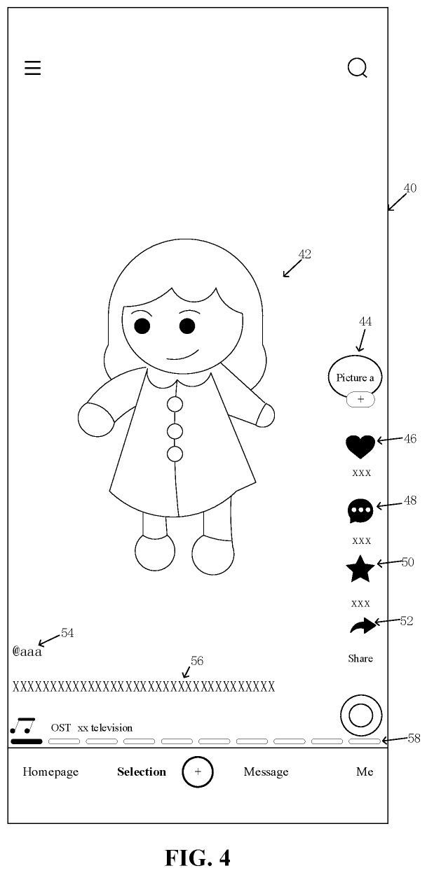

In some embodiments, the cover picture interface 40 is schematically shown in FIG. 4, wherein the cover picture interface displays a cover picture 42 of the picture set, an account identifier 54 of a user account that publishes the picture set, and text content 56 configured for the picture set by the user account. The cover picture 42 is any one of the plurality of pictures included in the picture set. In addition, the cover picture interface may further display an account avatar 44 of the user account posting the picture set and a variety of interactive options, including, for example, a “like” option 46, a number of “likes”, a “comment” option 48, a number of “comments”, a “favorite” option 50, a number of “favorites”, a “share” option 52, and the like. The number of “likes” indicates the number of user accounts performing the interaction operations of “like” on the picture set, the number of “comments” indicates the number of user accounts performing the interaction operations of “comment” on the picture set, and the number of “favorites” indicates the number of user accounts performing the interaction operations of “favorite” on the picture set.

In the illustrated embodiment, the account identifier 54 of the user account is “aaa”, the text content 56 configured for the picture set by the user account is “XXXXXXXXX”, and the account avatar 44 of the user account posting the picture set is “picture a”, and the number of likes is “xxx”, the identifier of the number of comments is “xxx”, and the number of favorites is “xxx”. On the cover picture interface, the progress bar 58 is configured to trigger the display of different pictures.

In S220, the electronic device determines, in response to a trigger operation on the progress bar, the plurality of pictures to be displayed from the picture set and the thumbnails of the plurality of pictures.

In some embodiments of the present disclosure, the trigger operation of the user on the progress bar includes a slide operation or a long-press operation on the switch element.

That is, when the electronic device displays the cover picture interface, the user performs, based on the cover picture interface, the trigger operation on the progress bar, and then the electronic device determines, in response to the trigger operation of the user on the progress bar in the cover picture interface, a plurality of pictures to be displayed from the picture set and thumbnails of the plurality of pictures. In addition, the electronic device switches the cover picture interface. In some embodiments, the electronic device switches the cover picture interface to an interface including the first picture of the picture set, the thumbnails of the pictures, and the switch elements corresponding to the thumbnails, wherein the switched interface is also referred to as an actual browsing interface or a target interface of the picture set in the present disclosure.

In some embodiments, the display position of each of the elements of the progress bar on the cover picture interface is the same as the display position of each of the switch elements on the actual browsing interface (i.e., the target interface) of the picture set, and the electronic device determines, based on the display position of each of the switch elements, the display position of the thumbnail corresponding to the switch element. In some embodiments, the display position of the thumbnail corresponding to each of the switch elements is above the switch element, and the distance between the thumbnail and the corresponding switch element is a target distance determined based on the size of the actual interface, which is not limited in the present disclosure.

In some embodiments, the electronic device switches, based on a target trigger operation of the user on the cover picture interface, the cover picture interface to the actual browsing interface of the picture set. The target trigger operation may be a trigger operation on the progress bar described above. Alternatively, the target trigger operation includes a long-press operation, a slide operation, a slide operation performed within a target period of time upon the long-press operation, etc. on any area of the cover picture. In some embodiments, the slide operation is a slide operation along a horizontal direction.

Based on the above solutions, the cover picture interface is switched, and a next interface is displayed through various trigger operations, such that the diversity of interface switching modes is improved, and the simplicity and the accuracy of interactions between the user and the electronic device are enhanced.

In some embodiments, in S110, determining, in response to the picture set display operation, the plurality of pictures to be displayed from the picture set is performed by the following processes:

determining, in response to the picture set display operation, a preceding target number of pictures in the picture set as target pictures to be displayed based on a display sequence of pictures in the picture set. The preceding target number of pictures is the predetermined number of pictures that appear earlier in the display sequence of the picture set.

In some embodiments, the display sequence of pictures in the picture set is an uploading sequence in which the user account uploads the pictures in the picture set, or a display sequence of the pictures defined upon the picture set is uploaded. The preceding target number is configured based on a predetermined display policy, namely the preceding target number is a predetermined number; or, the preceding target number is a number determined based on actual requirements, wherein the determination process is detailed in the following description.

In some embodiments, the electronic device determines the display sequence of pictures in the picture set based on the picture uploading sequence, or determines the display sequence of pictures in the picture set based on the picture display sequence triggered by the user.

In the embodiments of the present disclosure, the electronic device acquires, based on the display sequence of pictures in the picture set, a picture sequence of the plurality of pictures in the picture set, and determines a preceding target number of pictures in the picture sequence as the plurality of pictures to be displayed. Further, the electronic device acquires, based on the picture sequence, a sequence of thumbnails of the plurality of pictures, and a sequence of switch elements of the thumbnails.

Based on the above solutions, the plurality of pictures to be displayed are determined based on the display sequence defined by the user, and the thumbnails of the plurality of pictures are displayed on the interface in time, which facilitates interactions among different accounts and ensures the picture browsing efficiency.

In some embodiments, the target interface includes a thumbnail display region configured to display thumbnails of the plurality of target pictures. The interface is the target interface displayed on the electronic device in process S220, and the target interface includes a picture display region, for example, a background region. In addition, the interface further includes the thumbnail display region in which a plurality of thumbnails are displayed, wherein the thumbnails are one-to-one corresponding to the plurality of pictures to be displayed determined in the foregoing embodiments. The interface further includes a switch element display region in which switch elements corresponding to the thumbnails are displayed. The display position of the thumbnail display region corresponds to the display position of the switch element display region, which is, in some embodiments, an aligned display style.

In some embodiments, prior to determining, in response to the picture set display operation, the preceding target number of pictures in the picture set as the plurality of pictures to be displayed based on a display sequence of pictures in the picture set, the method for displaying information further includes the following process:
determining the preceding target number based on the size of the thumbnail display region and the sizes of the thumbnails.

In some embodiments of the present disclosure, prior to determining the plurality of pictures to be displayed, the electronic device acquires the size of the thumbnail display region and the sizes of the thumbnails, such that the electronic device determines, based on the size of the thumbnail display region and the sizes of the thumbnails, the number of the thumbnails displayed on the interface, that is the preceding target number. In some embodiments, the size of the thumbnail display region is a size in the horizontal direction, such as a first size; the size in the horizontal direction of the interface is a second size; the sizes of the thumbnails of different pictures is uniform, such as the size of a thumbnail in the horizontal direction is a third size; the second size is the same as the first size; and the electronic device determines the preceding target number based on the second size and the third size.

In some embodiments, a quotient of the second size and the third size is determined as the preceding target number.

In some embodiments, the electronic device determines the preceding target number based on a predetermined display policy. In some embodiments, the electronic device acquires a number pre-configured by an operation and maintenance person of the application program, wherein the number is a maximum number of thumbnails that can be displayed on the interface, and determines the maximum number as the target number.

The electronic device selects, based on the requirements of an actual application scenario, a determination mode of the target number, which is not limited in the present disclosure.

Based on the above solutions, the number of the displayed thumbnails is determined based on the actual size of the interface, such that the compatibility and the practicability are guaranteed, the maximization of the display of the picture set information is guaranteed, and the determination modes of the target number are enriched.

In some embodiments, in S130, said switching, in response to the trigger operation on the switch elements, to display the pictures corresponding to the switch elements on the target interface is performed by the following processes:
determining, in response to the trigger operation of the user on the switch elements, a trigger sequence of the switch elements, and sequentially displaying, based on the trigger sequence, the pictures corresponding to the switch elements.

In some embodiments, the trigger operation of the user on the switch elements is a slide operation, for example, a slide operation on the switch elements in the horizontal direction.

In some embodiments of the present disclosure, the user performs, based on an actual picture browsing requirement, the trigger operation on the switch elements displayed on the interface. Accordingly, in response to the trigger operation, the electronic device sequentially displays, based on a sequence in which the switch elements are triggered in a time dimension, the pictures corresponding to the switch elements on the interface.

In some embodiments, the electronic device displays, in response to the picture set display operation, an interface including a cover picture of the picture set, thumbnails of the pictures, and switch elements corresponding to the thumbnails, and the user can perform, based on an actual picture browsing requirement, a slide operation on the switch elements corresponding to the thumbnails. Then, in response to the slide operation, the electronic device updates, based on a sequence in which the switch elements are triggered in a time dimension, the cover picture being displayed on the interface to a picture corresponding to the switch element, and then displays, as the user slides to the other switch elements, pictures corresponding to the other switch elements on the interface, so as to achieving to switch and display the plurality of pictures on the interface.

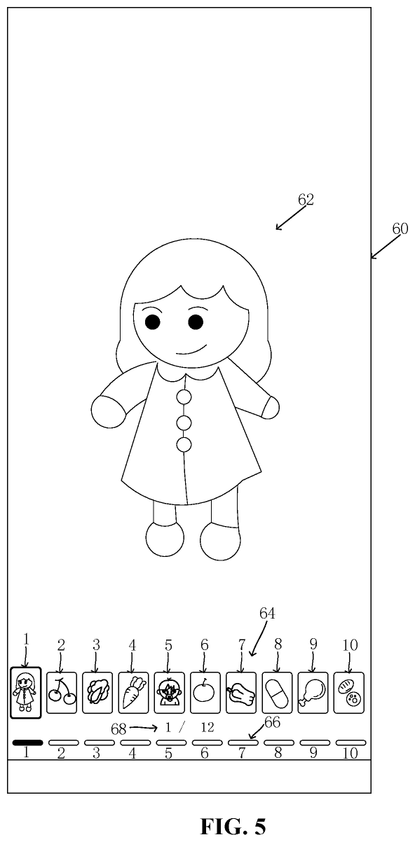

FIG. 5 is a schematic diagram of an interface according to some embodiments of the present disclosure. In some embodiments, as shown in FIG. 5, the electronic device displays, in response to the picture set display operation, an interface including thumbnails of the pictures and switch elements corresponding to the thumbnails. The interface 60 is a target interface or actual browsing interface. In some embodiments, the interface 60 displays a first picture 62 (picture 1), thumbnails 64 of a preceding target number of pictures, and switch elements 66 corresponding to the preceding target number of thumbnails, wherein the pictures in the thumbnails include the pictures first appearing in the display sequence of the picture set, i.e., the picture 1, picture 2, picture 3, picture 4, picture 5, picture 6, picture 7, picture 8, picture 9, and picture 10. The picture set has twelve pictures. The thumbnails 64 displayed on the interface 60 include thumbnails corresponding to pictures 1 to 10, and the interface 60 further displays switch elements 66 corresponding to the thumbnails. The first picture 62 is displayed at a picture display region. An arrangement sequence of the switch elements 66 is the same as an arrangement sequence of the thumbnails. In some embodiments, the interface 60 is displayed upon switching from a cover picture interface (the cover picture interface illustrated in FIG. 4 for example). The switch elements 66 have the same configurations as the elements in a progress bar on the cover picture interface, and are displayed on the same positions as the progress bar. In the illustrated embodiment, the switch elements 66 are configured to include a plurality of bars with a space between each other, and are arranged in a horizontal direction. The display positions of the switch elements 66 are below the corresponding thumbnail. The thumbnails and the switch elements are in one-to-one correspondence. In addition, the interface 60 further includes an arrangement sequence identifier 68 of the currently displayed picture in the picture set, wherein the arrangement sequence identifier 68 changes in real-time with the change of the currently displayed picture. In some embodiments, the picture displayed on the interface shown in FIG. 5 is a first picture, and the arrangement sequence thereof in the picture set is 1, accordingly, the arrangement sequence identifier 68 is 1/12. In some embodiments, when the picture 1 is displayed, the configuration of the corresponding thumbnail and the switch elements are shown differently to distinguish with other thumbnails. In the illustrated example, the corresponding thumbnail is shown with a bold frame and a larger size. Further, the corresponding switch element is shown in a solid bar as opposed to other switch elements. It should be appreciated that the switch elements may have any appropriate configurations such as dots, and the switch elements may be disposed on any appropriate positions such as disposed above the thumbnails.

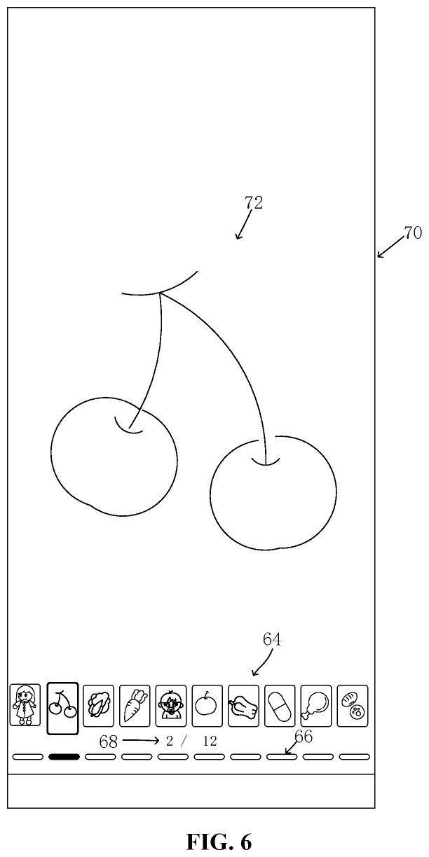

Referring FIGS. 5-6, a user can perform, based on an actual picture browsing requirement, a slide operation on the switch elements 66, and accordingly, the electronic device switches, based on the sequence of the switch elements triggered by the slide operation, to display pictures. In some embodiments, a target picture is displayed at a picture display region on the target interface, wherein the target picture corresponds to a target switch element at a position where the slide operation ends. In some embodiments, according to the trigger sequence of the user, switch element 1 and switch element 2 are triggered in succession. In response, the electronic device updates the displayed picture, and the target interface 60 shown in FIG. 5 is switched to an interface 70 as shown in FIG. 6. The displayed picture 62 corresponding to thumbnail 1 in FIG. 5 is updated to the displayed picture 72 corresponding to thumbnail 2 as shown in FIG. 6. Further, the corresponding arrangement sequence identifier is updated to 2/12. The user can perform a slide operation from one switch element to another switch element.

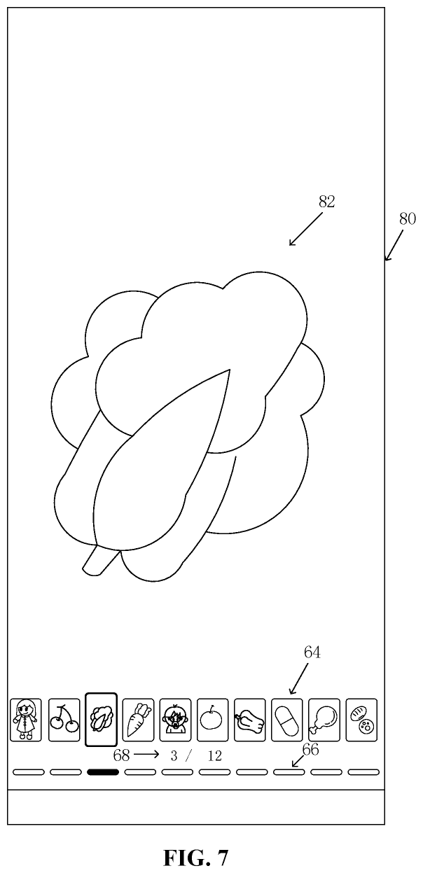

Referring to FIGS. 6-7, the user can continuously perform, based on the actual browsing requirement, the trigger operation. In the case that the electronic device determines that the switch element 2 being triggered is changed from the switch element 2 to the switch element 3, the electronic device updates the displayed picture, and the interface 70 shown in FIG. 6 is switched to an interface 80 as shown in FIG. 7. The displayed picture 72 corresponding to thumbnail 2 in FIG. 6 is updated to the displayed picture 82 corresponding to thumbnail 3 as shown in FIG. 7. Further, the corresponding arrangement sequence identifier is updated to 3/12. The arrangement sequence identifier changes along with the movement of the pictures, and the change logic is sequentially changing, that is, one by one.

In the embodiments of the present disclosure, the change of the picture display is accomplished by a user to perform an operation on the switch elements corresponding to the thumbnails rather than dragging the thumbnails directly. The switch elements have a one-by-one relationship with the thumbnails, and are disposed separated from the thumbnails. In this way, the user can clearly see the thumbnails while triggering the switch elements, and thus can select the pictures correctly and easily, which enhances the browsing efficiency.

In some embodiments, the sizes of the thumbnails are different. In some embodiments, the electronic device determines a target thumbnail corresponding to the current trigger operation in the thumbnail sequence and adjusts the position of the thumbnail sequence in the thumbnail display region to ensure that the target thumbnail is displayed at a target position in the thumbnail display region. In some embodiments, the target position is a central position.

In some embodiments, the sizes of two thumbnails adjacent to the target thumbnail are the same and are both smaller than the size of the target thumbnail, that is, the sizes sequentially decrease, so that the display styles of the thumbnails are enriched, and the user experience of browsing pictures is improved.

In some embodiments, the method for displaying information further includes: displaying, in response to a select operation on a target switch element, a target thumbnail corresponding to the target switch element at a target position of the thumbnail display region; wherein sizes of the thumbnails on left and right sides of the target thumbnail sequentially decrease, and are all smaller than the size of the target thumbnail; and the size of the i^{th} thumbnail on the left side of the target thumbnail is consistent with the size of the i^{th} thumbnail on the right side of the target thumbnail, wherein i is a positive integer. In some embodiments, the value of i is 3, which is not limited in the present disclosure.

In some embodiments, the sizes of the thumbnails on the left and right sides of the target thumbnail sequentially decrease, and are all smaller than the size of the target thumbnail until the (i+1)^{th} thumbnails on the left and right sides of the target thumbnail. That is, the size of the target thumbnail is the largest, and the sizes of the thumbnails on the left and right sides thereof sequentially decrease, and then an arc is formed. In other words, not only the size of the target thumbnail becomes the largest to highlight the effect of sliding to the target thumbnail, but also the sizes of the thumbnails on the left and right sides sequentially decrease. In some embodiments, the sizes of the first thumbnails on the left and right sides of the target thumbnail decrease to be smaller than the target thumbnail, and so on until the third thumbnails on the left and right sides of the target thumbnail; and the size of the fourth thumbnails on the left and right sides of the target thumbnail return to the normal size.

In some embodiments, in the case that the cover picture interface is switched to the target interface, the electronic device does not support automatic playing at this time, and the automatic playing function is recovered in response to the stop of the trigger operation of the user. In the case that the target thumbnail is displayed with a predetermined display effect, a predetermined sound effect, such as vibration feedback, is added at the same time. In the case that the trigger operation reaches the first picture or the last picture, and the trigger position of the user is at the edge of the electronic device, the picture displayed on the interface stops updating.

Based on the above solutions, the real-time performance of the picture display is improved, the consistency of the switch elements triggered by the user and the pictures displayed on the interface is ensured, and the picture browsing experience of the user and the smoothness of switching and display among different pictures are improved.

In some embodiments, the method for displaying information further includes:
displaying, in response to a select operation on a target switch element, a picture corresponding to the target switch element on the target interface, and displaying the target switch element and a thumbnail corresponding to the target switch element with a predetermined display effect.

In some embodiments, the predetermined display effect is a display effect that is pre-configured, such as a highlight display effect or an enlargement display effect. That is, the predetermined display effect is different from the current display effect of other unselected switch elements.

In some embodiments of the present disclosure, the user performs the trigger operation on a plurality of switch elements.

Based on the above solutions, the switch elements and the pictures currently selected by the user are displayed with a specific display effect, such that the prompt information is diversified, and the currently selected content of the user is accurately prompted simply and conveniently.

In some embodiments, upon switching, in response to the trigger operation on the switch elements, to display the pictures corresponding to the switch elements on the target interface, the method for displaying information further includes:
hiding, in response to stop of the trigger operation, the thumbnails of the pictures on the target interface.

In the embodiments of the present disclosure, the electronic device switches, in response to the trigger operation of the user on the switch elements, to display the pictures corresponding to the switch elements on the target interface, for example, switching to display based on the sequence of the switch elements triggered by the user. On the basis of the above, upon the above process, in the case that the trigger operation of the user on the switch elements stops, for example, a finger performing the trigger operation has left the display screen of the electronic device, the electronic device hides the thumbnails of the pictures. That is, in the above case, the electronic device does not display the thumbnails of the pictures, and only displays the switch elements corresponding to the pictures and a picture corresponding to a switch element that is triggered last at the end time of the trigger operation.

Based on the above solutions, the operation of the user is responded in real-time, the simplicity and convenience of interface information display are ensured, and the user can browse the pictures conveniently.

In some embodiments, said determining, in response to the trigger operation on the progress bar, the plurality of pictures to be displayed from the picture set is achieved by the following processes:
determining, in response to a slide operation on the progress bar along a first direction, the plurality of pictures to be displayed from the picture set.

In some embodiments, the first direction is horizontal. In some embodiments, the first direction is a direction from left to right.

In the embodiments of the present disclosure, the user performs, based on the progress bar included in the cover picture interface displayed on the electronic device and based on a browsing requirement for the plurality of pictures in the picture set in which the cover picture is included, a trigger operation on the progress bar. In some embodiments, the trigger operation is a slide operation from left to right. The electronic device determines, in response to the slide operation, the plurality of pictures to be displayed from the picture set in which the cover picture is included, switches the cover picture interface to display the target interface including the thumbnails of the pictures and the switch elements corresponding to the thumbnails.

Based on the above solutions, the real-time performance of the display and the picture browsing experience of the user are improved.

It should be understood that although the various processes in the flowcharts of FIGS. 2-3 are shown in order as indicated by the arrows, the processes are not necessarily performed in order as indicated by the arrows. The processes are not limited to being performed in the exact order illustrated and, unless explicitly stated herein, may be performed in other orders. Moreover, at least some of the processes in FIGS. 2-3 include multiple processes or multiple stages, which are not necessarily performed at the same time, but may be performed at different moments, and the processes or stages are not necessarily sequentially performed, but may be performed alternately with other processes or at least some of the processes or stages among other processes.

It can be understood that the same/similar parts among the various embodiments of the method described above in this description are referred to each other, and each embodiment focuses on the differences between the embodiments with the other embodiments, and where relevant, reference is made to the description of the other method embodiments.

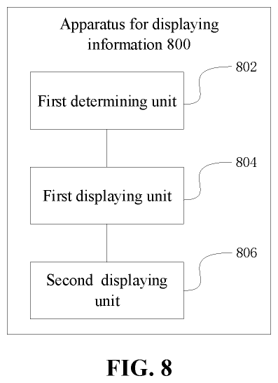

FIG. 8 is a block diagram of an apparatus for displaying information according to some embodiments of the present disclosure. Referring to FIG. 8, the apparatus 800 for displaying information includes a first determining unit 802, a first displaying unit 804, and a second displaying unit 806.

The first determining unit 802 is configured to determine, in response to a picture set display operation, a plurality of pictures to be displayed from a picture set and thumbnails of the plurality of pictures.

The first displaying unit 804 is configured to display a target interface, wherein the target interface includes the thumbnails of the plurality of pictures and switch elements corresponding to the thumbnails, wherein the pictures and the thumbnails are in one-to-one correspondence, and the thumbnails and the switch elements are in one-to-one correspondence.

The second displaying unit 806 is configured to switch, in response to a trigger operation on the switch elements, to display pictures corresponding to the switch elements on the target interface.

In some embodiments, the first determining unit 802 is configured to:
display a cover picture interface of the picture set in response to the picture set display operation, wherein the cover picture interface includes a progress bar, the progress bar including a plurality of elements; and
determine, in response to a trigger operation on the progress bar, the plurality of pictures to be displayed from the picture set and the thumbnails of the plurality of pictures; wherein the switching elements on the target interface are displayed at the same positions as the elements of the progress bar, and displayed below the thumbnails.

In some embodiments, the first determining unit 802 is configured to:
determine, in response to the picture set display operation, a preceding target number of pictures in the picture set as the plurality of pictures to be displayed along with the thumbnails based on a display sequence of pictures in the picture set.

In some embodiments, the target interface includes a thumbnail display region configured to display the thumbnails of the plurality of pictures; and the apparatus 800 for displaying information further includes:
a second determining unit, configured to determine the target number based on a size of the thumbnail display region and a size of the thumbnail; or, a third determining unit, configured to determine the target number based on a predetermined display policy.

In some embodiments, the second displaying unit 806 is configured to:
determine, in response to the trigger operation on the switch elements, a trigger sequence of the switch elements, and sequentially display, based on the trigger sequence, the pictures corresponding to the switch elements.

In some embodiments, the apparatus 800 for displaying information further includes:
a third displaying unit, configured to display, in response to a select operation on a target switch element, a picture corresponding to the target switch element on the target interface, and display the target switch element and a thumbnail corresponding to the target switch element with a predetermined display effect.

In some embodiments, the apparatus 800 for displaying information further includes:
a hiding unit, configured to hide, in response to stop of the trigger operation, the thumbnails of the pictures on the target interface.

In some embodiments, the first determining unit 804 is configured to:
determine, in response to a slide operation on the switch elements along a first direction, the plurality of pictures from the picture set.

In some embodiments, the target interface includes a thumbnail display region configured to display the thumbnails of the plurality of pictures; and the apparatus 800 for displaying information further includes:
a fourth displaying unit, configured to display, in response to a select operation on a target switch element, a target thumbnail corresponding to the target switch element at a target position in the thumbnail display region;
wherein sizes of thumbnails on left and right sides of the target thumbnail sequentially decrease, and are all smaller than a size of the target thumbnail; and
a size of an i^{th} thumbnail on the left side of the target thumbnail is consistent with a size of an i^{th} thumbnail on the right side of the target thumbnail, wherein i is a positive integer.

In some embodiments, the sizes of the thumbnails on the left and right sides of the target thumbnail sequentially decrease, and are all smaller than the size of the target thumbnail until (i+1)^{th} thumbnails on the left and right sides of the target thumbnail.

With regard to the apparatus in the above embodiments, the specific manner in which each unit operates has been described in detail in the embodiments related to the method, and is not described in detail herein.

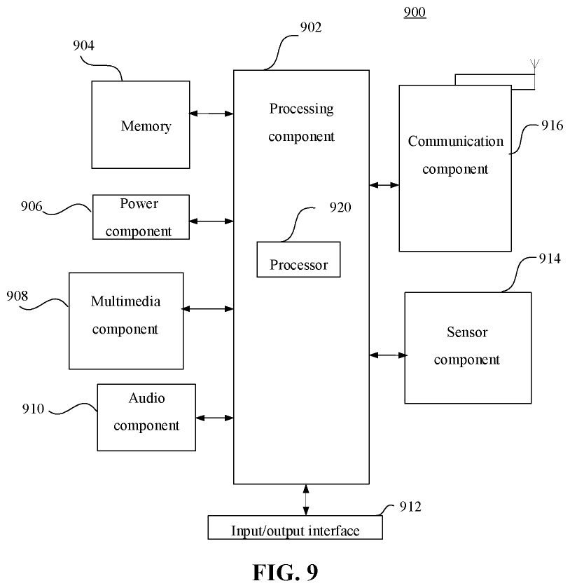

FIG. 9 is a block diagram of an electronic device 900 for displaying information according to some embodiments of the present disclosure.

Referring to FIG. 9, the electronic device 900 includes one or more of the following components: a processing component 902, a memory 904, a power component 906, a multimedia component 908, an audio component 910, an input/output (I/O) interface 912, a sensor component 914, and a communication component 916.

The processing component 902 generally controls the overall operation of the electronic device 900, such as operations associated with display, telephone calls, data communications, camera operations, and recording operations. The processing component 902 includes one or more processors 920 to execute instructions to perform all or some of the processes of the method for displaying information described above. Moreover, the processing component 902 includes one or more modules to facilitate the interactions between the processing component 902 and other components. In some embodiments, the processing component 902 includes a multimedia module to facilitate the interaction between the multimedia component 908 and the processing component 902.

The memory 904 is configured to store various types of data to support the operations on the electronic device 900. Examples of such data include instructions for any application program or method operating on the electronic device 900, contact data, phonebook data, messages, pictures, videos, and the like. The memory 904 is achieved by any type or combination of transitory or non-transitory storage devices, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, an optical disk, or a graphene memory.

The power component 906 provides power for the various components of the electronic device 900. The power component 906 includes a power management system, one or more power supplies, and other components associated with generating, managing, and distributing power for the electronic device 900.

The multimedia component 908 includes a screen providing an output interface between the electronic device 900 and a user. In some embodiments, the screen includes a liquid crystal display (LCD) and a touch panel (TP). In the case that the screen includes a touch panel, the screen is implemented as a touch screen to receive an input signal from a user. The touch panel includes one or more touch sensors to sense touch, slides, and gestures on the touch panel. The touch sensors not only sense the boundary of a touch or slide action, but also detect the duration and pressure associated with the touch or slide operation. In some embodiments, the multimedia component 908 includes a front camera and/or a rear camera. The front camera and/or the rear camera receive external multimedia data in the case that the electronic device 900 is in an operation mode, such as a shooting mode or a video mode. Each of the front camera and the rear camera is a fixed optical lens system or has a focal length and an optical zoom capability.

The audio component 910 is configured to output and/or input audio signals. In some embodiments, the audio component 910 includes a microphone (MIC). In the case that the electronic device 900 is in an operation mode, such as a call mode, a recording mode, and a voice recognition mode, the microphone (MIC) is configured to receive external audio signals. The received audio signals are further stored in the memory 904 or transmitted via the communication component 916. In some embodiments, the audio component 910 further includes a speaker configured to output audio signals.

The I/O interface 912 provides an interface between the processing component 902 and a peripheral interface module, wherein the peripheral interface module includes a keyboard, a click wheel, a button, or the like. The buttons include, but are not limited to: a homepage button, a volume button, a start button, and a lock button.

The sensor component 914 includes one or more sensors configured to provide various aspects of state evaluation for the electronic device 900. In some embodiments, the sensor component 914 detects an open/closed state of the electronic device 900 and the relative positioning of components, wherein the components include a display and a keypad of the electronic device 900. The sensor component 914 further detects a change in the position of the electronic device 900 or components of the electronic device 900, whether a user contacts with the electronic device 900, orientation or acceleration/deceleration state of the device 900, and a change in temperature of the electronic device 900. The sensor component 914 includes a proximity sensor configured to detect the presence of nearby objects in the absence of any physical contact. The sensor component 914 further includes a light sensor, such as a CMOS or CCD image sensor, configured to be used in imaging applications. In some embodiments, the sensor component 914 further includes an acceleration sensor, a gyroscope sensor, a magnetic sensor, a pressure sensor, or a temperature sensor.

The communication component 916 is configured to facilitate the communications between the electronic device 900 and other devices in a wired or wireless manner. The electronic device 900 accesses a wireless network based on a communication standard, such as WiFi, an operator network (such as 2G, 3G, 4G, or 5G), or a combination thereof. In some embodiments, the communication component 916 receives a broadcast signal or broadcast-associated information from an external broadcast management system via a broadcast channel. In some embodiments, the communication component 916 further includes a near-field communication (NFC) module to facilitate short-range communications. In some embodiments, the NFC module is implemented based on radio frequency identification (RFID) technology, infrared data association (IrDA) technology, ultra-wideband (UWB) technology, bluetooth (BT) technology, or other technologies.

In some embodiments, the electronic device 900 is implemented by one or more application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic elements to perform the method for displaying information described above. Namely, an electronic device is provided. The electronic device includes:
one or more processors; and
a memory, configured to store one or more instructions executable by the one or more processors;
wherein the one or more processors, when loading and executing the one or more instructions, are configured to:
determine, in response to a picture set display operation, a plurality of pictures to be displayed from a picture set and thumbnails of the plurality of pictures;
display a target interface, wherein the target interface includes the thumbnails of the plurality of pictures and switch elements corresponding to the thumbnails, wherein the pictures and the thumbnails are in one-to-one correspondence, and the thumbnails and the switch elements are in one-to-one correspondence; and
switch, in response to a trigger operation on the switch elements, to display pictures corresponding to the switch elements on the target interface.

In some embodiments, the one or more processors, when loading and executing the one or more instructions, are further configured to:
display a cover picture interface of the picture set in response to the picture set display operation, wherein the cover picture interface includes a progress bar, the progress bar including a plurality of elements; and
determine, in response to a trigger operation on the progress bar, the plurality of pictures to be displayed from the picture set and the thumbnails of the plurality of pictures; wherein the switching elements on the target interface are displayed at the same positions as the elements of the progress bar, and displayed below the thumbnails.

In some embodiments, the one or more processors, when loading and executing the one or more instructions, are further configured to:
determine, in response to the picture set display operation, a preceding target number of pictures in the picture set as the plurality of pictures to be displayed along with the thumbnails based on a display sequence of pictures in the picture set.

In some embodiments, the target interface includes a thumbnail display region configured to display the thumbnails of the plurality of pictures; and
the one or more processors, when loading and executing the one or more instructions, are further configured to:
determine the target number based on a size of the thumbnail display region and a size of the thumbnail; or
determine the target number based on a predetermined display policy.

In some embodiments, the one or more processors, when loading and executing the one or more instructions, are further configured to:
determine, in response to the trigger operation on the switch elements, a trigger sequence of the switch elements, and sequentially display, based on the trigger sequence, the pictures corresponding to the switch elements.

In some embodiments, the one or more processors, when loading and executing the one or more instructions, are further configured to:
display, in response to a select operation on a target switch element, a picture corresponding to the target switch element on the target interface, and display the target switch element and a thumbnail corresponding to the target switch element with a predetermined display effect.

In some embodiments, the one or more processors, when loading and executing the one or more instructions, are further configured to:
hide, in response to stop of the trigger operation, the thumbnails of the pictures on the target interface.

In some embodiments, the one or more processors, when loading and executing the one or more instructions, are further configured to:
determine, in response to a slide operation on the switch elements along a first direction, the plurality of pictures from the picture set.

In some embodiments, the target interface includes a thumbnail display region configured to display the thumbnails of the plurality of pictures; and
the one or more processors, when loading and executing the one or more instructions, are further configured to:
display, in response to a select operation on a target switch element, a target thumbnail corresponding to the target switch element at a target position of the thumbnail display region;
wherein sizes of thumbnails on left and right sides of the target thumbnail sequentially decrease, and are all smaller than a size of the target thumbnail; and
a size of an i^{th} thumbnail on the left side of the target thumbnail is consistent with a size of an i^{th} thumbnail on the right side of the target thumbnail, wherein i is a positive integer.

In some embodiments, the sizes of the thumbnails on the left and right sides of the target thumbnail sequentially decrease, and are all smaller than the size of the target thumbnail until (i+1)^{th} thumbnails on the left and right sides of the target thumbnail.

In some embodiments, a non-transitory computer-readable storage medium storing one or more instructions executable by a processor is further provided, such as a memory 904 including instructions. The instructions, when loaded and executed by a processor 920 of an electronic device 900, cause the electronic device 900 to perform the method for displaying information described above. In some embodiments, the computer-readable storage medium is ROM, random-access memory (RAM), CD-ROM, magnetic tape, floppy disk, optical data storage device, etc.

In some embodiments, a computer program product storing one or more instructions executable by a processor is further provided. The instructions, when loaded and executed by a processor 920 of an electronic device 900, cause the electronic device 900 to perform the method for displaying information described above.

It should be noted that the apparatus, the electronic device, the computer-readable storage medium, the computer program product, and the like as described above may further include other embodiments by referring to the method embodiments, and the specific implementation may refer to the descriptions of the related method embodiments, which are not described in detail herein.

Other embodiments of the present disclosure are apparent to those skilled in the art from consideration of the description and practice of the present invention disclosed herein. The present disclosure is intended to cover any variations, uses, or adaptations of the present disclosure following the general principles of the present disclosure and including known common knowledge or customary technical means undisclosed in the art of the present disclosure. The description and embodiments are only considered as exemplary, and a true scope and concept of the present disclosure are indicated in the claims.

It should be understood that the present disclosure is not limited to the precise arrangements that have been described above and shown in the accompanying drawings, and that various modifications and changes can be made without departing from the scope thereof. The scope of the present disclosure is limited only by the appended claims.

What is claimed is:

1. A method for displaying information, applicable to an electronic device, the method comprising:
determining, in response to a picture set display operation, a plurality of pictures to be displayed from a picture set and thumbnails of the plurality of pictures;
displaying a target interface, wherein the target interface comprises the thumbnails of the plurality of pictures and switch elements corresponding to the thumbnails, wherein the pictures and the thumbnails are in one-to-one correspondence, and the thumbnails and the switch elements are in one-to-one correspondence; and
switching, in response to a trigger operation on the switch elements, to display pictures corresponding to the switch elements on the target interface.

2. The method according to claim 1, wherein said determining, in response to the picture set display operation, the plurality of pictures to be displayed from the picture set and the thumbnails of the plurality of pictures comprises:
displaying a cover picture interface of the picture set in response to the picture set display operation, wherein the cover picture interface comprises a progress bar, the progress bar comprising a plurality of elements; and
determining, in response to a trigger operation on the progress bar, the plurality of pictures to be displayed from the picture set and the thumbnails of the plurality of pictures;
wherein the switching elements on the target interface are displayed at the same positions as the elements of the progress bar, and displayed below the thumbnails.

3. The method according to claim 1, wherein said determining, in response to the picture set display operation, the plurality of pictures to be displayed from the picture set comprises:
determining, in response to the picture set display operation, a preceding target number of pictures in the picture set as the plurality of pictures to be displayed along with the thumbnails based on a display sequence of the pictures in the picture set.

4. The method according to claim 3, wherein the target interface comprises a thumbnail display region configured to display the thumbnails of the plurality of pictures; and
the method further comprises:
determining the preceding target number based on a size of the thumbnail display region and a size of the thumbnail; or
determining the preceding target number based on a predetermined display policy.

5. The method according to claim 1, wherein said switching, in response to the trigger operation on the switch elements, to display the pictures corresponding to the switch elements on the target interface comprises:
determining, in response to the trigger operation on the switch elements, a trigger sequence of the switch elements, and sequentially displaying, based on the trigger sequence, the pictures corresponding to the switch elements.

6. The method according to claim 1, further comprising:
displaying, in response to a select operation on a target switch element, a picture corresponding to the target switch element on the target interface, and displaying the target switch element and a thumbnail corresponding to the target switch element with a predetermined display effect.

7. The method according to claim 1, further comprising:
hiding, in response to stop of the trigger operation, the thumbnails of the pictures on the target interface.

8. The method according to claim 2, wherein said determining, in response to the trigger operation on the progress bar, the plurality of pictures from the picture set comprises:
determining, in response to a slide operation on the switch elements along a first direction, the plurality of pictures from the picture set.

9. The method according to claim 1, wherein the target interface comprises a thumbnail display region configured to display the thumbnails of the plurality of pictures; and
the method further comprises:
displaying, in response to a select operation on a target switch element, a target thumbnail corresponding to the target switch element at a target position in the thumbnail display region;
wherein sizes of thumbnails on left and right sides of the target thumbnail sequentially decrease, and are all smaller than a size of the target thumbnail; and
a size of an i^{th} thumbnail on the left side of the target thumbnail is consistent with a size of an i^{th} thumbnail on the right side of the target thumbnail, wherein i is a positive integer.

10. The method according to claim 9, wherein the sizes of the thumbnails on the left and right sides of the target thumbnail sequentially decrease, and are all smaller than the size of the target thumbnail until (i+1)^{th} thumbnails on the left and right sides of the target thumbnail.

11. An electronic device, comprising:
one or more processors; and
a memory, configured to store one or more instructions executable by the one or more processors;
wherein the one or more processors, when loading and executing the one or more instructions, are configured to:
determine, in response to a picture set display operation, a plurality of pictures to be displayed from a picture set and thumbnails of the plurality of pictures;
display a target interface, wherein the target interface comprises the thumbnails of the plurality of pictures and switch elements corresponding to the thumbnails, wherein the pictures and the thumbnails are in one-to-one correspondence, and the thumbnails and the switch elements are in one-to-one correspondence; and
switch, in response to a trigger operation on the switch elements, to display pictures corresponding to the switch elements on the target interface.

12. The electronic device according to claim 11, wherein the one or more processors, when loading and executing the one or more instructions, are further configured to:
display a cover picture interface of the picture set in response to the picture set display operation on an application program, wherein the cover picture interface comprises a progress bar, the progress bar comprising a plurality of elements; and
determine, in response to a trigger operation on the progress bar, the plurality of pictures to be displayed from the picture set and the thumbnails of the plurality of pictures;
wherein the switching elements on the target interface are displayed at the same positions as the elements of the progress bar, and displayed below the thumbnails.

13. The electronic device according to claim 11, wherein the one or more processors, when loading and executing the one or more instructions, are further configured to:
determine, in response to the picture set display operation, a preceding target number of pictures in the picture set as the plurality of pictures to be displayed along with the thumbnails based on a display sequence of the pictures in the picture set.

14. The electronic device according to claim 13, wherein the target interface comprises a thumbnail display region configured to display the thumbnails of the plurality of pictures; and
the one or more processors, when loading and executing the one or more instructions, are further configured to:
determine the preceding target number of pictures based on a size of the thumbnail display region and a size of the thumbnail; or
determine the preceding target number of pictures based on a predetermined display policy.

15. The electronic device according to claim 11, wherein the one or more processors, when loading and executing the one or more instructions, are further configured to:
determine, in response to the trigger operation on the switch elements, a trigger sequence of the switch elements, and sequentially display, based on the trigger sequence, the pictures corresponding to the switch elements.

16. The electronic device according to claim 11, wherein the one or more processors, when loading and executing the one or more instructions, are further configured to:
display, in response to a select operation on a target switch element, a picture corresponding to the target switch element on the target interface, and display the target switch element and a thumbnail corresponding to the target switch element with a predetermined display effect.

17. The electronic device according to claim 11, wherein the one or more processors, when loading and executing the one or more instructions, are further configured to:
hide, in response to stop of the trigger operation, the thumbnails of the pictures on the target interface.

18. The electronic device according to claim 12, wherein the one or more processors, when loading and executing the one or more instructions, are further configured to:
determine, in response to a slide operation on the switch elements along a first direction, the plurality of pictures from the picture set.

19. The electronic device according to claim 11, wherein the target interface comprises a thumbnail display region configured to display the thumbnails of the plurality of pictures; and
the one or more processors, when loading and executing the one or more instructions, are further configured to:
display, in response to a select operation on a target switch element, a target thumbnail corresponding to the target switch element at a target position in the thumbnail display region;
wherein sizes of thumbnails on left and right sides of the target thumbnail sequentially decrease, and are all smaller than a size of the target thumbnail; and
a size of an i^{th} thumbnail on the left side of the target thumbnail is consistent with a size of an i^{th} thumbnail on the right side of the target thumbnail, wherein i is a positive integer.

20. A non-transitory computer-readable storage medium storing one or more instructions executable by a processor;
wherein the processor, when loading and executing the one or more instructions, is configured to:
determine, in response to a picture set display operation, a plurality of pictures to be displayed from a picture set and thumbnails of the plurality of pictures;
display a target interface, wherein the target interface comprises the thumbnails of the plurality of pictures and switch elements corresponding to the thumbnails; and
switch, in response to a trigger operation on the switch elements, to display pictures corresponding to the switch elements on the target interface.
